(19) United States
(12) Patent Application Publication
(10) Pub. No.: US 2026/0173026 A1
(43) Pub. Date: Jun. 18, 2026

(54) METHODS AND APPARATUS TO SUPPORT POSITIONING DELEGATION FUNCTIONALITY IN WIRELESS NETWORKS

(71) Applicant: INTERDIGITAL PATENT HOLDINGS, INC., Wilmington, DE (US)

(72) Inventors: Oumer TEYEB, Montreal (CA); Dylan WATTS, Montreal (CA); Jaya RAO, Montreal (CA); Fumihiro HASEGAWA, Westmount (CA)

(73) Assignee: INTERDIGITAL PATENT HOLDINGS, INC., Wilmington, DE (US)

(21) Appl. No.: 19/115,524

(22) PCT Filed: Sep. 28, 2023
(86) PCT No.: PCT/US2023/034041

§ 371 Date: Mar. 26, 2025

Related U.S. Application Data
(60) Provisional application No. 63/410,871, filed on Sep. 28, 2022.

(51) Int. Cl. H04W 64/00; H04W 74/0836; H04W 76/27

(52) U.S. Cl. CPC H04W 64/006; H04W 74/0836; H04W 76/27

(57) ABSTRACT

A method may comprise receiving information related to position delegates. The information may be used while in a first activity level. The information may be received while in a second activity level, during a transition from the second activity level to the first activity level, or while in the first activity level. The method may comprise receiving information about the positioning capabilities of the position delegates in response to an explicit request or via broadcast information. The method may comprise choosing a position delegate based on a need or condition, which may comprise at least on of: a desired accuracy level, a best signal level, or a higher layer application need. The method may comprise receiving location information from the chosen position delegate. The method may comprise repurposing existing messages to request location information and receive location information while in the first activity level.

### CROSS-REFERENCE TO RELATED APPLICATIONS

This application claims the benefit of U.S. Provisional Application No. 63/410,871, filed Sep. 28, 2022, the contents of which are incorporated herein by reference.

### BACKGROUND

Integrated Access and Backhaul (IAB), where part of the wireless spectrum is used for the backhaul connection of base stations instead of fiber, allows a more flexible and cheaper deployment of dense networks as compared to deployments where there is a dedicated fiber link to the base stations. The IAB node's protocol stack is divided in User Plane (UP) and Control Plane (CP). Both the UP and CP architectures employ a routing/forwarding approach inspired by IP networks, where each IAB node is assigned an IP address that is routable from a donor base station, and intermediate IAB nodes forward the packets transparently based on route identifiers/destination addresses. A CU/DU split architecture may be used, in which case the IAB-node terminates the DU functionality and a base station (referred to as IAB-donor) terminates the CU functionality. One of the use case scenarios for IABs is the support of Mobile IABs. Mobile IABs may be used to provide connectivity to a multitude of WTRUs while on the move. Mobile IAB nodes would be installed in e.g., trains, buses, airplanes and remain in close proximity to the WTRU. Additionally, in these use cases, multiple WTRUs may remain in close proximity of each other for a long period of time. The location of the WTRUs may be substantially the same. Performing the positioning for each WTRU independently may be suboptimal. It may be advantageous if a mobile IAB node, or other similar entity that can provide connectivity to a multitude of WTRUs that are in close proximity of each other and are likely to move in tandem, may act as a position delegate for the WTRUs that it is serving. This may reduce WTRU power consumption and signaling overhead.

### SUMMARY

A method, which may be implemented by a WTRU, may comprise receiving information related to one or more position delegates. The information may be used while in a first activity level. The information related to one or more position delegates may be received while in a second activity level, during a transition from the second activity level to the first activity level, or while in the first activity level. The first activity level may be a Radio Resource Control (RRC) IDLE or an RRC INACTIVE connection mode and the second activity level may be an RRC CONNECTED mode. The method may comprise receiving information about the positioning capabilities of the one or more position delegates. The information about the positioning capabilities of the one or more position delegates may be received in response to an explicit request or via broadcast information. The method may comprise transitioning from the second activity level to the first activity level in response to a received message. The received message may be a Radio Resource Control (RRC) release message. The method may comprise choosing a position delegate based on a need or condition. The need or condition may comprise at least one of: a desired accuracy level, a best signal level, or a higher layer application need. The method may comprise receiving location information from the chosen position delegate. The location information may be received from the chosen position delegate while in the first activity level. The location request and reception of the location information from the chosen position delegate is performed using Small Data Transmission (SDT) procedures and resources. The location information may be received periodically. The location information may be received intermittently. The method may comprise sending a request for location information in a Msg1 message during a 4-step random access procedure and receiving the location information in a Msg2 message. The method may comprise sending a request for location information in a MsgA message during a 2-step random access procedure and receiving the location information in a MsgB message. The method may comprise sending a request for location information in a Msg3 message and receiving the location information in a Msg4 message. The Msg3 message may be an RRC resume request message. The Msg4 message may be an RRC release message or an RRC resume message.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example Wireless Transmit/Receive Unit (WTRU) that may be used within the communications system illustrated in FIG. 1A according to an embodiment;

FIG. 1C is a system diagram illustrating an example Radio Access Network (RAN) and an example core network (CN) that may be used within the communications system illustrated in FIG. 1A according to an embodiment;

FIG. 1D is a system diagram illustrating a further example RAN and a further example Core Network (CN) that may be used within the communications system illustrated in FIG. 1A according to an embodiment;

FIG. 2 shows an example of the Location Management architecture;

FIG. 3 shows an example IAB of the split architecture with User Plane and Control Plane separation;

FIG. 4 shows an example of the IAB architecture;

FIG. 5 shows an example of IAB User Plane;

FIG. 6 shows an example of IAB Control Plane;

FIG. 7 shows an example use case scenario;

FIG. 8 shows an RRC Connection Setup call flow;

FIG. 9 shows an RRC Connection Resume call flow;

FIG. 10 shows the different RRC modes and transitions between the modes;

FIG. 11 shows messaging exchange for a 4-step random access procedure;

FIG. 12 shows messaging exchange for a 2-step random access procedure;

FIG. 13 shows an example where the location information may be sent in the broadcast channel or via a dedicate request/response process;

FIG. 14 shows a high level view of an example of the position delegation process;

FIG. 15 shows an example where the configuration may be sent to the WTRU while the WTRU is in RRC CONNECTED mode; and

FIG. 16 shows an example where the configuration may be sent to the WTRU when the WTRU is in RRC IDLE or RRC INACTIVE mode.

### DETAILED DESCRIPTION

The following abbreviations and acronyms may be referred to herein:
AMF Access and Mobility management Function
AoA Angle of Arrival
BAP Backhaul Adaptation Protocol
CB Contention-Based
CBRA Contention Based Random Access
CFRA Contention Free Random Access
CG Configured Grant
CHO Conditional Handover
CPRI Common Public Radio Interface
CP Control Plane
CN Core Network (e.g., LTE packet core)
CU Central Unit
CUPS Control and User Plane Separation
DCI Downlink Control Information
DL Downlink
DN Data Network
DU Distributed Unit
eCPRI enhanced Common Public Radio Interface
EPC Evolved Packet Core
GTP GPRS Tunneling Protocol
IAB Integrated Access and Backhaul
IP Internet Protocol
LCS Location Services
LMF Location Management Function
LPP LTE Positioning Protocol
LTE Long Term Evolution e.g., from 3GPP LTE R8+
MAC Medium Access Control
MIMO Multiple Input Multiple Output
MME Mobility Management Entity
Multi-RTT Multi-cell Round Trip Time
NAS Non-Access Stratum
NR New Radio e.g., from 3GPP R15+
NRPPa NR Positioning Protocol A
OFDM Orthogonal Frequency-Division Multiplexing
PGW Packet Gateway
PHY Physical Layer
PRACH Physical Random Access Channel
PDCP Packet Data Convergence Protocol
PDU Protocol Data Unit
PLMN Public Land Mobile Network
PRS Positioning Reference Signal
QoS Quality of Service
RACH Random Access Channel (or procedure)
RAN Radio Access Network
RAR Random Access Response
RNTI Radio Network Temporary Identifier
RF Radio Frontend
RLC Radio Link Control
RRC Radio Resource Control
RS Reference Signal
RSRP Reference Signal Receive Power
RSTD Reference Signal Time Delay
RTT Round Trip Time
RU Radio Unit
SDAP Service Data Adaptation Protocol
SDT Small Data Transmission
SGW Serving Gateway
SMF Session Management Function
SRB Signaling Radio Bearer
SRS Sounding Reference Signal
TA Timing Advance
TDOA Time Difference of Arrival
TRP Transmission/Reception Point
UL Uplink
UDP User Datagram Protocol
UP User Plane
UPF User Plane Function
WLAN Wireless Local Area Networks and related technologies (IEEE 802.xx domain)
WTRU Wireless Transmit/Receive Unit

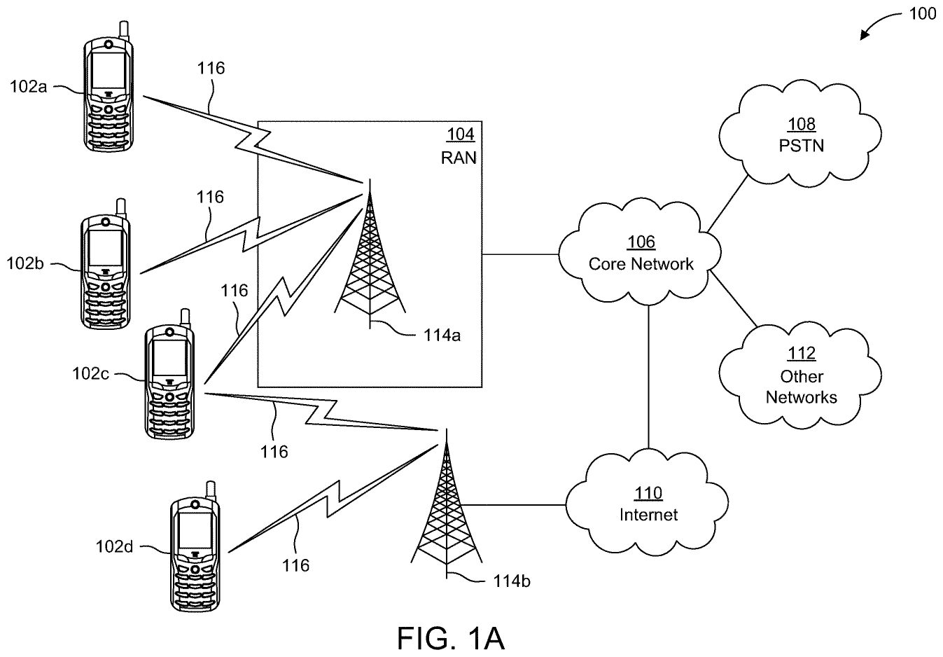

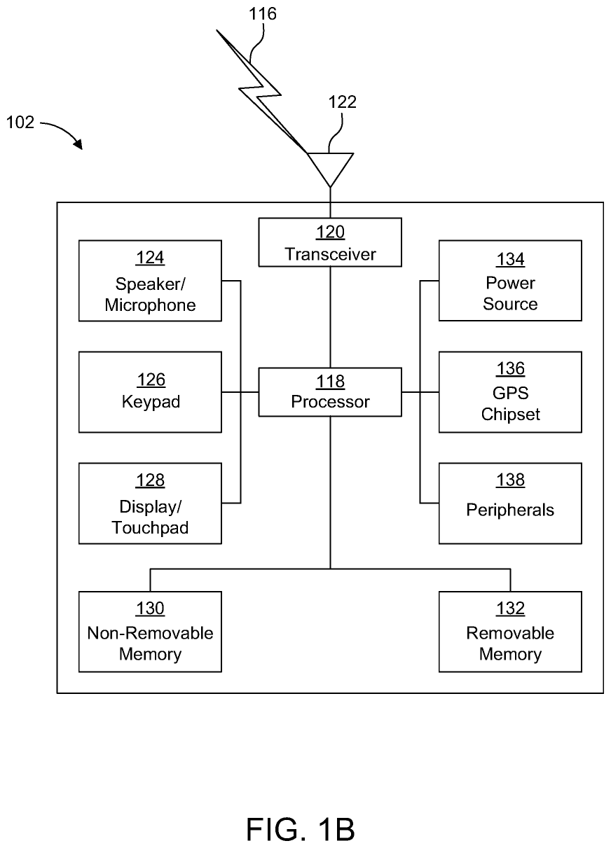

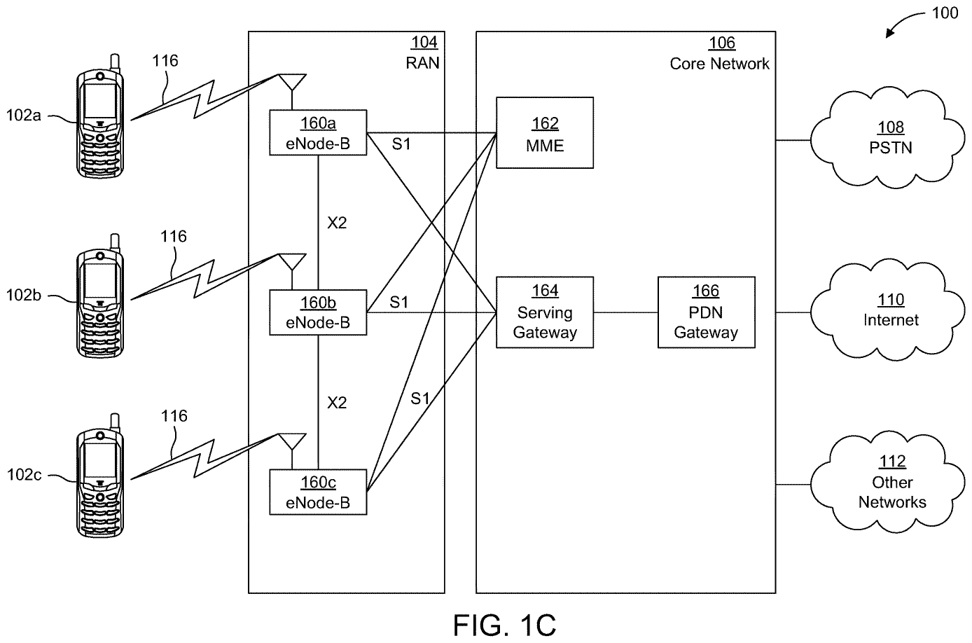

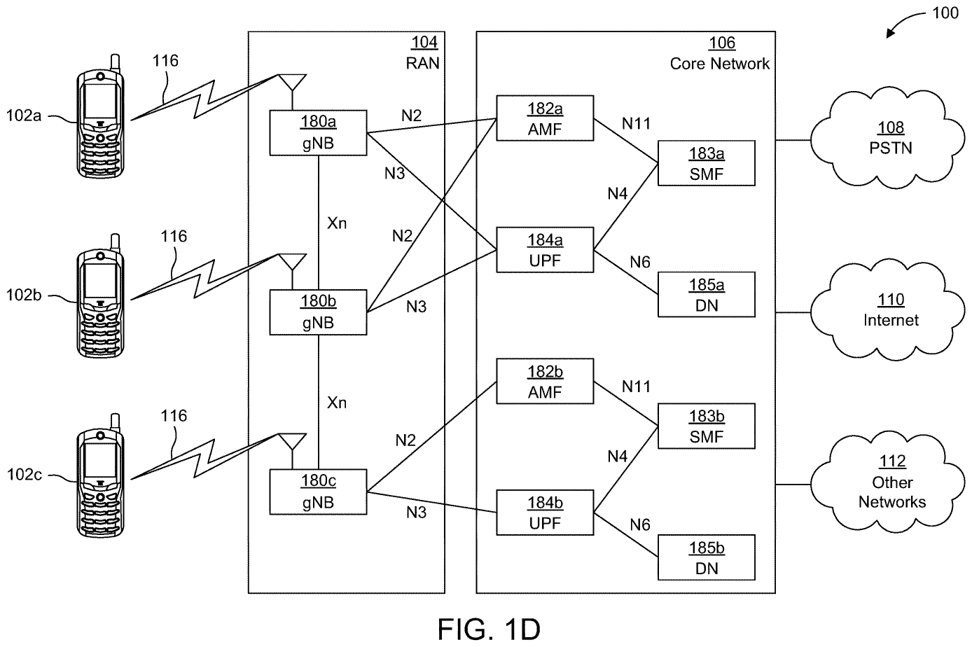

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The 3GPP standards support location service features, i.e., features that allow to identify the likely location of specific WTRUs (Wireless Transmit/Receive Unit). The location may be used for e.g., charging, lawful interception, emergency calls, and to support location-based services such as push advertisement. Location services may enable many new applications that rely on location. All 3GPP technologies (e.g., NG-RAN, E-UTRAN, GERAN and UTRAN) have features used to facilitate determination of the location of the WTRU (e.g., WTRU).

Location Information includes geographic location (e.g., latitude and longitude), velocity (e.g., speed and direction), or civic location (e.g., address). Important factors to consider for location services include positioning accuracy, response time, reliability, priority, and security, among others.

The 3GPP architecture for location services includes an Location Services (LCS) client, an LCS server, a positioning function, and the target WTRU (e.g., target WTRU). An LCS server is located in the 3GPP network, and provides a platform to enable the support of location based services together with other communication services such as speech, data, messaging, etc. An LCS client is a logical functional entity that makes a request to the LCS server for the location information of one or more than one target WTRUs within a specified set of parameters (e.g., QoS requirements). The LCS client may reside in an entity within the PLMN network to enable the provisioning of operator-based services or in an entity external to the PLMN network, such as in an application server. The LCS client may also reside in the WTRU, such as application running in the WTRU which may need location information. The LCS client is the requestor of location information; an LCS server may respond to a location request from an authorized LCS client with location information for the target WTRUs (specified by the LCS client) if considerations of target WTRU privacy are satisfied.

The positioning function is the basic function that determines the location of a specific target WTRU. The target WTRU is the object to be positioned by the LCS server. The trigger to this function is a positioning request from an LCS client with a set of parameters such as QoS requirements. The end result of this function is the location information for the target WTRU. For network-based positioning methods, no support for LCS is required by the target WTRU. For mobile-assisted and mobile-based positioning methods, the target WTRU actively supports LCS.

Throughout this document the terms LCS server and the Location Management Function (LMF) are used interchangeably. In addition, the examples provided in this document are 3GPP specific, and moreover 5G specific. However, use of these terms are not in any way limiting as the concept is applicable to other network technologies providing location services.

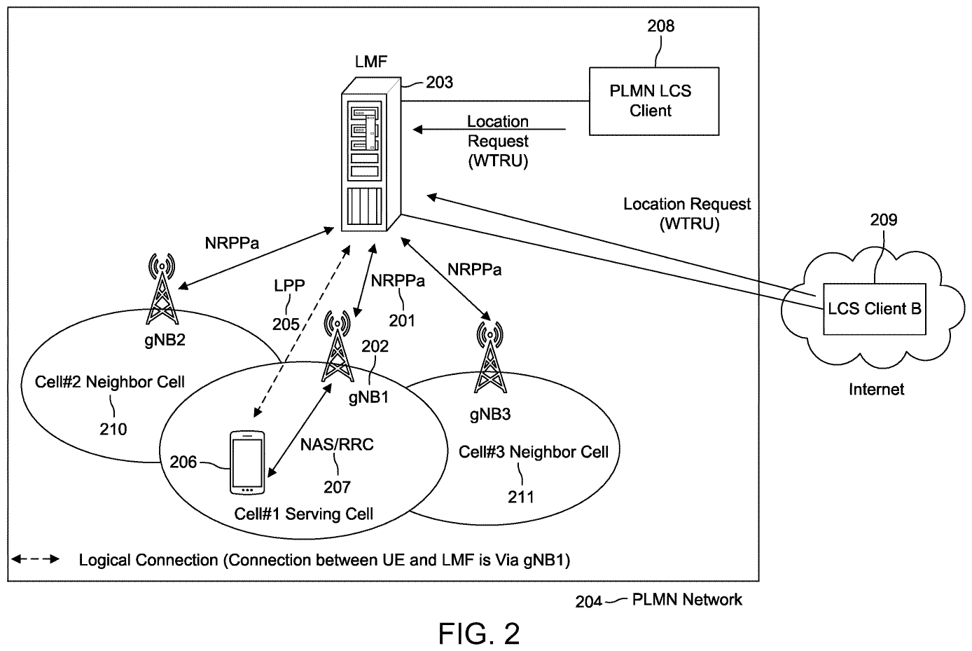

FIG. 2 shows an example of the Location Management architecture in a PLMN network, depicting the relevant protocols used in 3GPP 5GNR. The NR Positioning Protocol A (NRPPa) 201 is used between gNBs 202 and a Location Management Function (LMF) 203. The LMF 203 resides in the 3GPP Network 204. The LTE Positioning Protocol (LPP) 205 is used between a WTRU 206 and the LMF 203. The interface between WTRU 206 and LMF 203 is a logical interface 205, and the WTRU 206 may communicate with the LMF 203 via the gNB 202, which uses RRC and NAS protocols (NAS messages are carried in RRC PDUs) 207. An LCS client may be inside the PLMN network 208, or in an application server outside the PLMN network (e.g., in the Internet or part of a private network) 209. The LCS client may send requests to the LCS server asking for the location of a specific WTRU.

The LMF functionality determines the positioning method to be supported by a WTRU (e.g., WTRU-assisted/WTRU-based and/or DL-based/UL-based) based on positioning capability information sent by the WTRU. In one example, LMF functionality provides Positioning Reference Signal (PRS) configuration to a WTRU (for DL-based positioning) and Sounding Reference Signal (SRS) configuration to a gNBs/TRPs (for UL-based positioning). For WTRU-assisted positioning, the LMF performs the calculation of the WTRU location based on a measurement report sent by the WTRU. For WTRU-based positioning, the WTRU sends the location information to the LMF, which then forwards the WTRU location WTRU to the LCS client.

Referring to FIG. 2, the SRS and/or PRS configurations may be sent from the LMF 203 to the gNB/TRP 202 using the NRPPa protocol 201, so that the gNB/TRP knows what to transmit/receive to support WTRU 206 positioning. The LMF 203 may also send PRS to the neighboring cells 210, 211, as the WTRU 206 may use the PRS associated with gNBs/TRPs in both serving 202 and neighboring cells 210, 211. The LMF 203 may use the LPP protocol 205 to send measurements details to the WTRU 206 with information regarding what and how to measure. The WTRU 206 may use LPP 205 to transmit its positioning capability information, an assistance data request (e.g., in case the WTRU does not have any PRS configurations), measurement reports for WTRU-assisted positioning, and location information for WTRU-based positioning. LPP messages may be carried in NAS PDUs encapsulated in RRC messages (WTRU <->gNB<->AMF <->LMF). For DL-based positioning, the WTRU may obtain the PRS configuration via posSIB. The WTRU 206 may also request the gNB 202 to configure a measurement gap before the WTRU 206 starts performing measurements of DL-PRS. For UL-based positioning, the WTRU 206 may receive an SRS configuration from the serving gNB 202. When the LMF 203 receives, from the LCS client 208, 209, a request for location of a specific WTRU, the LMF 203 may send a location request to the WTRU 206 using the LPP protocol 205. The WTRU 206 may then start performing measurements and execute the positioning process.

In the descriptions herein, the following positioning methods are considered. A Downlink (DL) positioning method may refer to any positioning method that uses downlink reference signals such as PRS. The WTRU may receive multiple reference signals from the gNBs/TRP(s) and measure a DL Reference Signal Time Delay (RSTD) and/or Reference Signal Received Power (RSRP). Examples of DL positioning methods include DL Angle of Arrival (AoD) and DL Time Difference of Arrival (TDOA) positioning. An Uplink (UL) positioning method may refer to any positioning method that uses uplink reference signals such as positioning SRS. The WTRU may transmit SRS to multiple TRPs and the TRPs may measure the UL Relative Time of Arrival (RTOA) and/or RSRP. Examples of UL positioning methods include UL-TDOA or UL-AoA positioning. A DL and UL positioning method may refer to any positioning method that uses both uplink and downlink reference signals for positioning. In an example, a WTRU may transmit SRS to multiple TRPs and a gNB may measure a Rx-Tx time difference. The gNB may measure RSRP of the received SRS. The WTRU may measure a Rx-Tx time difference for PRS transmitted from multiple TRPs. The WTRU may measure RSRP of the received PRS. The Rx-TX difference and possibly RSRP measured at the WTRU and gNB may be used to compute a round trip time. Here, Rx and Tx difference refers to the difference between arrival time of the reference signal transmitted by the TRP and transmission time of the reference signal transmitted from the WTRU. An example of DL and UL positioning method is multi-cell Round Trip Time (multi-RTT) positioning.

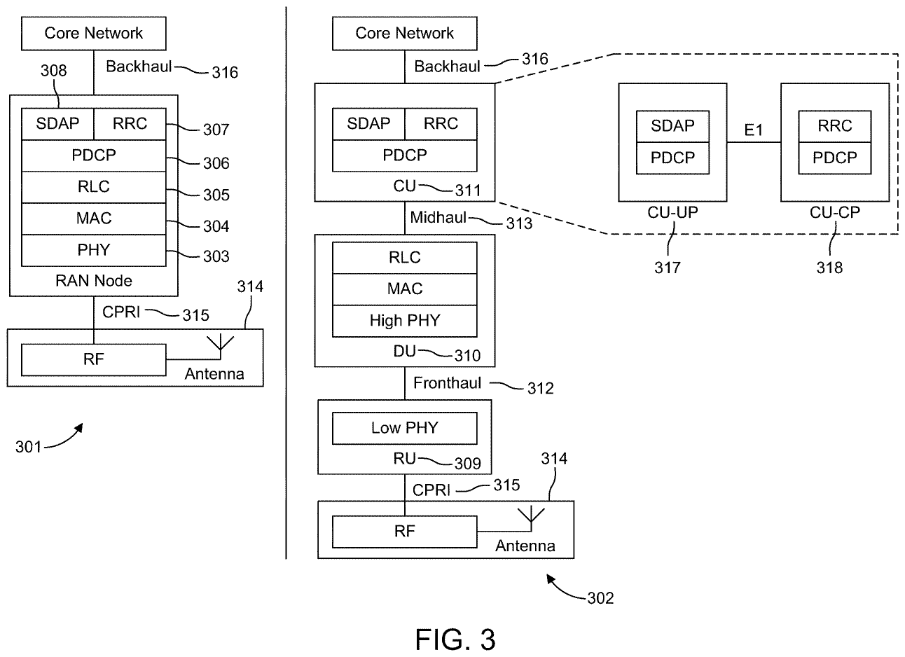

3GPP release 15 specifications introduced a split architecture where 3 sub-components of the gNB are defined. FIG. 3 shows an example of the split architecture with User Plane and Control Plane separation. Referring to FIG. 3, the monolithic 301 and the split 302 architectures are depicted. In FIG. 3, the legacy RAN Node (i.e., monolithic RAN Node) 301 is illustrated. A RAN Node may be an eNB, a gNB, etc. In the monolithic architecture, all of the sub-components of the RAN Node, i.e., PHY 303, MAC 304, RLC 305, PDCP 306, RRC 307 and SDAP 308, are part of a single component, and therefore they are all installed in the same location. In the split architecture 302, the RAN Node is split in Radio Unit (RU) 309, Distributed Unit (DU) 310 and Centralized Unit (CU) 311. The interface between the RU 309 and the DU 310 is referred to as fronthaul 312; the interface between the DU 310 and the CU 311 is referred to as midhaul 313. In the split architecture, the midhaul 313 and the fronthaul 312 interfaces are standardized and clearly specified in the standards, allowing RAN vendors to specialize in different components, and operators to use components from different vendors in their network.

It is noted that, for ease of installation, the RF and the antenna 314 may be installed in a different location from RAN node (in the monolithic architecture 301) or from the RU (in the split architecture 302). For example, for the case of a macro-cell, the RF and the antenna 314 may be installed at the top of a tower, and the remainder of the sub-components may be installed at the bottom of the tower, and they may be connected using a Common Public Radio Interface (CPRI) interface 315, which is TDM serial interface, standardized, and the same for both architectures. In the split architecture, enhanced Common Public Radio Interface (eCPRI) is used in the fronthaul 312. Enhanced CPRI (eCPRI) is a packet-based technology, using Ethernet/IP. Additionally, in the split architecture, there is an option of using Control and User Plane Separation (CUPS), which comprises the separation of the CU 311 in the CU User Plane (CU-UP) 317 and the CU Control Plane (CU-CP) 318. Finally, in both architectures, the backhaul 316 connects the RAN to the Core Network (CN).

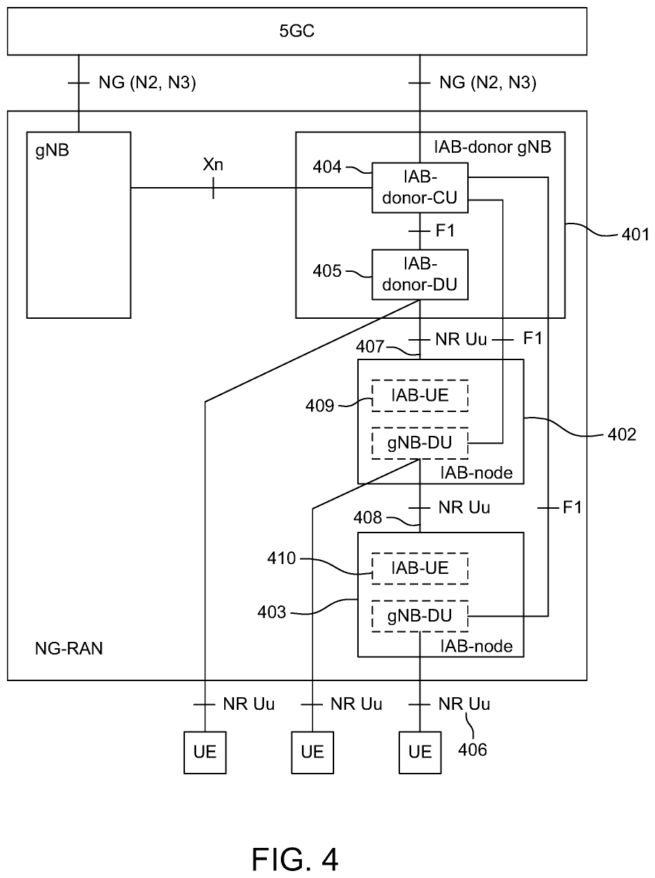

Integrated Access and Backhaul (IAB), where part of the wireless spectrum is used for the backhaul connection of base stations instead of fiber, allows a more flexible and cheaper deployment of dense networks as compared to deployments where there is a dedicated fiber link to the base stations. In release 16 of the 3GPP standards, a full-fledged, multi-hop, IAB solution based on the split architecture of release 15 has been specified for NR. FIG. 4 shows an example of the IAB architecture. There are two main components in the IAB architecture: an IAB-donor 401, which is a gNB, and an IAB-node 402, 403. Furthermore, the IAB architecture is based on the split architecture, so there are two parts of the IAB-donor: IAB-donor-CU 404 and IAB-donor-DU 405. The IAB system architecture enables the relaying of NR Uu access traffic 406 from the WTRU via NR Uu backhaul links 407, 408. The Uu backhaul links can exist between the IAB-node and IAB-donor (gNB) 407 or another IAB-node 408. In case two IAB nodes are connected, they may be referred as a parent IAB-node 402 and a child IAB-node.

There is a sub-component of the IAB-node that supports a WTRU-like functionality towards the IAB-donor 409 or towards a parent IAB-node 410, via the Uu backhaul. This enables the registration of the IAB node with the PLMN (or SNPN) and the management of the backhaul connectivity. This sub-component is referred to as IAB-WTRU or IAB-MT or IAB-UE 409, 410

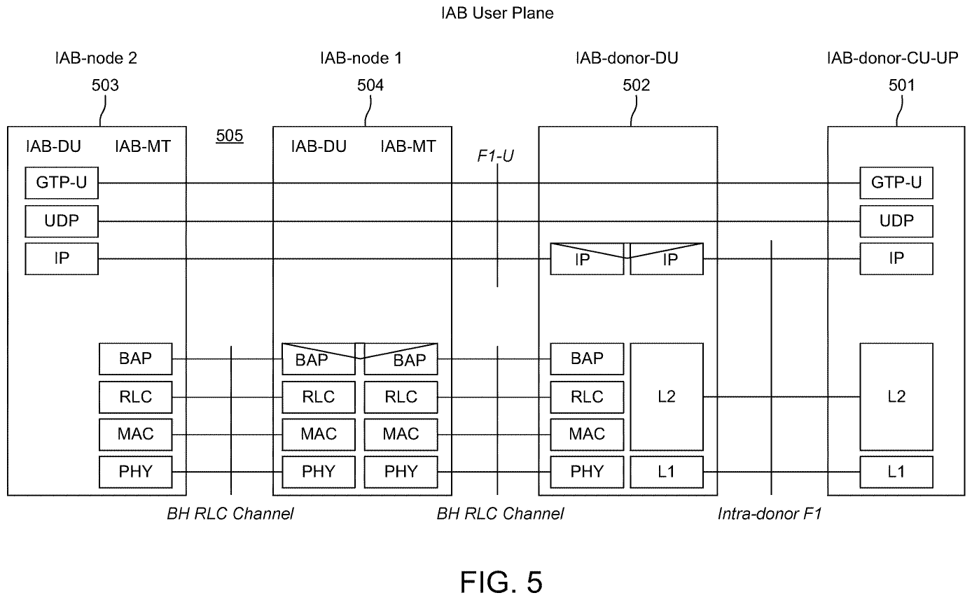

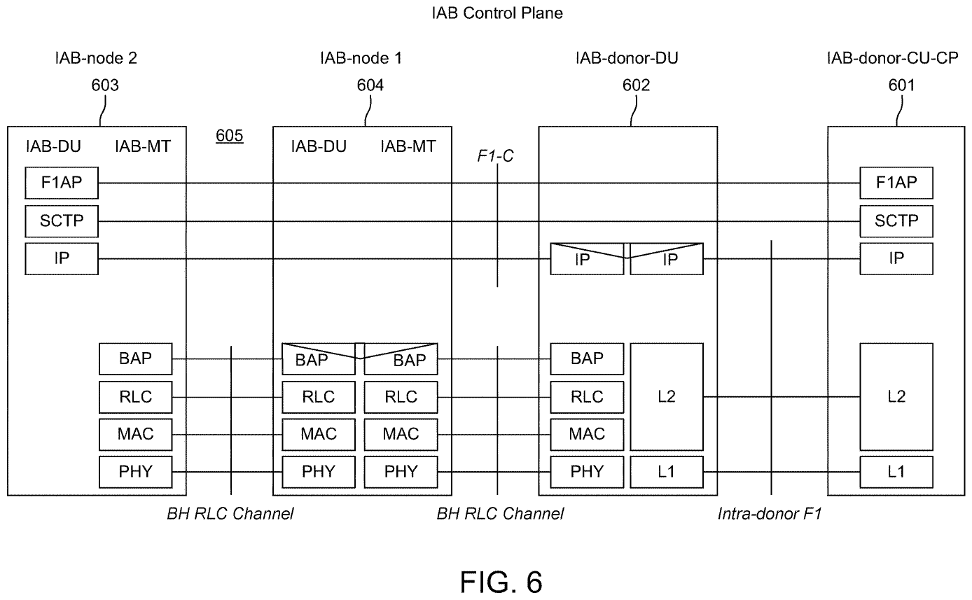

The protocol architecture for release 16 IAB is shown in FIG. 5 and FIG. 6 (as disclosed in 3GPP TR 38.834). FIG. 5 shows an example of IAB User Plane. FIG. 6 shows an example of IAB Control Plane.

The IAB-donor comprises an IAB-donor-CU and one or more IAB-donor-DU(s). In case of separation of gNB-CU-UP 501 and gNB-CU-CP 601, the IAB-donor may comprise an IAB-donor-CU-CP 601, one or more IAB-donor-CU-UPs 501 and one or more IAB-donor-DUs 502, 602. The IAB-nodes 503, 504, 603, 604 may connect to an upstream IAB-node (503, 603 connects to 504, 604) or to an IAB-donor-DU (502, 602, connects to 502, 602) via a subset of the WTRU functionalities of the NR Uu interface (named IAB-MT/IAB-WTRU function of IAB-node). The IAB-node provides wireless backhaul to the downstream IAB-nodes and WTRUs via the network functionalities of the NR Uu interface (named IAB-DU function of IAB-node).

In the User Plane, the F1-U traffic between an IAB-node 503, 504 and IAB-donor-CU-UP 501 is backhauled via the IAB-donor-DU 502, with optional intermediate hops between IAB-node(s) 505. In the Control Plane, the F1-C traffic between an IAB-node 603, 604 and IAB-donor-CU-CP 601 is backhauled via the IAB-donor-DU 602 and the optional intermediate hop between IAB-node(s) 605.

The IAB node's protocol stack contains two sides, the mobile termination (MT) part, which is used to communicate with a parent node, and a DU part, which is used to communicate with a child node or a normal WTRU. Both the UP and CP architectures employ a routing/forwarding approach inspired by IP networks, where each IAB node is assigned an IP address that is routable from a donor base station (and associated L2 addresses), and intermediate IAB nodes forward the packets transparently based on route identifiers/destination addresses. The IAB node terminates the DU functionality, and a base station (i.e., IAB-donor) terminates the CU functionality. Thus, the IAB node and donor CU, regardless of how many hops apart they are physically from each other, form one logical base station unit employing a CU/DU split architecture. The IAB node serving a WTRU is referred to as the access IAB node while the nodes between the IAB donor DU and the access IAB node are known as intermediate IAB nodes. It is noted that an IAB node can play the role of both an access IAB node (for the WTRUs that are directly connected to it) and an intermediate IAB node (for WTRUs that are served by its descendant IAB nodes).

One of the use case scenarios for IABs that is currently being studied in the release 18 of 3GPP standards is the support of mobile IABs that are used to provide connectivity to a multitude of WTRUs while on the move (e.g., on buses, trains, airplanes, etc.). The work item description can be found in the 3GPP tdoc RP-221815. Another use case, which is relevant even for release 16 IAB nodes is the IAB node acting as a Fixed Wireless Access (FWA) point of connectivity for multiple WTRUs (e.g., installed outside of homes, buildings, shopping malls, etc, and providing connectivity to the indoor WTRUs).

In the above cases where multiple WTRUs are in close proximity to each other (e.g., buses, trains, airplanes, in the same building, etc.), the location of the WTRUs may be significantly close and may be considered to be the same for applications that may not need a high level of accuracy. Performing the positioning (either WTRU-based or network-based) for each WTRU independently is thus suboptimal for many reasons such as: unnecessary WTRU power consumption (e.g., for performing PRS measurements, for sending SRSs, for performing GNSS measurements, etc.); unnecessary signaling and resource utilization in case the positioning is done via a mobile network (e.g., the sending of PRSs, the sending of SRSs, etc.); low positioning accuracy of GNSS in case of indoor WTRUs; and throughput loss of WTRUs in case mobile network-based positioning (as measurement gaps may be needed by the WTRU to perform the positioning related measurements).

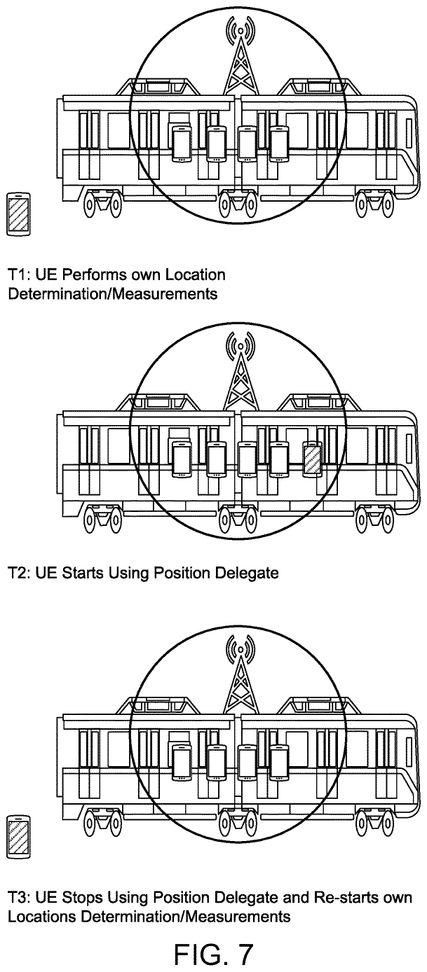

Thus, procedures have been proposed where a mobile IAB node (or other similar entity that can provide connectivity to a multitude of WTRUs in close proximity and likely to move in tandem) can act as a position delegate for the WTRUs that it is serving. An example use case scenario is shown in FIG. 7.

In NR, a WTRU may be in one of the following three RRC modes: RRC_CONNECTED (also referred to as “CONNECTED mode” in this disclosure); RRC_INACTIVE (also referred to as “INACTIVE mode” in this disclosure); and RRC_IDLE (also referred to as “IDLE mode” in this disclosure).

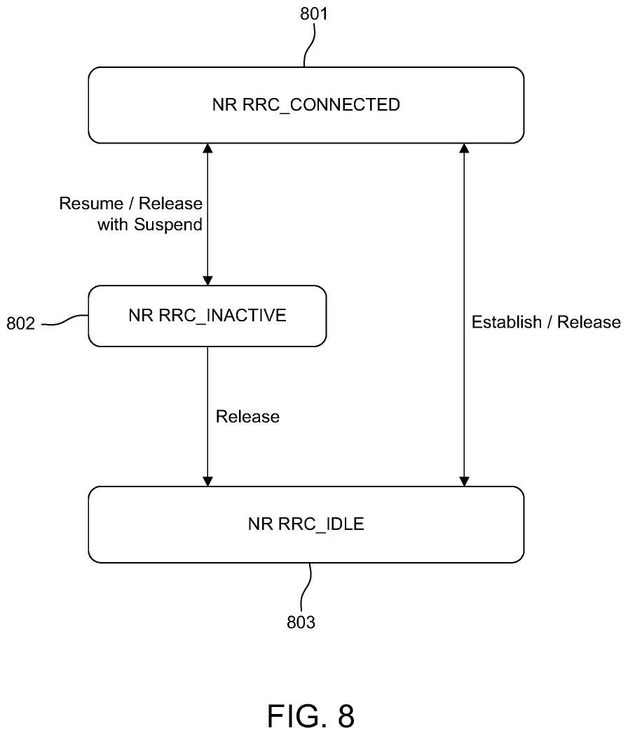

FIG. 8 shows the different RRC modes and transitions between the modes. In RRC_CONNECTED mode 801, the WTRU is actively connected to the network, with signaling and data radio bearers established (e.g., SRB and DRBs), and able to receive Downlink (DL) data from the network in a unicast fashion and also send Uplink (UL) data to the network. The mobility of the WTRU from one cell/node to another is controlled by the network. The network may configure the WTRU to send measurement reports periodically or when certain conditions are fulfilled (e.g., a neighbor cell becomes better than a serving cell by more than a certain threshold) and based on these reports may send the WTRU a handover command to move the WTRU to another cell/node. The network may also configure a conditional handover (CHO), where instead of sending of a measurement report, the WTRU executes a preconfigured handover command when certain conditions are fulfilled. The network may also send the WTRU a handover (HO) command without receiving any measurement report (e.g., based on implementation, such as the determination of current location).

Keeping the WTRU in a connected mode is power intensive for the WTRU (e.g., the WTRU needs to continuously monitor a PDCCH of the serving cell, for example, for determining the arrival of DL data, for UL data scheduling, etc.) and a certain cell/gNB is able to accommodate a certain number of WTRUs in a connected mode (e.g., due to resource limitations). As such, when there is no activity in the UL or DL for a certain duration (e.g., based on an inactivity timer kept at the network), the network may send or direct the WTRU to the RRC_INACTIVE 802 or RRC_IDLE 803 mode.

If the network expects the WTRU to become active for a long duration, it may direct the WTRU to RRC_IDLE mode 803. While in RRC_IDLE 803, the WTRU may camp on the best cell (e.g., the cell with the best signal level at the highest priority RAT and highest priority frequency within that RAT), that may facilitate the WTRU establishing the connection via that cell if a need arises for the WTRU to transition back to the connected mode. The WTRU also may monitor a downlink paging channel to detect for DL data arrival. The WTRU may initiate a connection setup/establishment procedure if it detects a page from the network indicating an arrival of a DL data or if the WTRU needs to send an UL data.

The random access procedure may be performed either in a contention-based fashion, referred to as Contention Based Random Access (CBRA) or contention free fashion, referred to as Contention Free Random Access (CFRA). During the RACH procedure, the WTRU may send a message on a RACH, referred to as Msg1, that contains a preamble and an RA-RNTI (Random Access-Radio Network Temporary Identifier) to the gNB. In the case of contention based random access (CBRA), the preamble is randomly selected out of a set of possible preamble values, which implies that there could be a contention if another WTRU initiates a random access procedure using the same preamble value. In the case of contention free random access (CFRA), a specific preamble is provided to the WTRU beforehand (e.g., when the WTRU was in CONNECTED mode, during the transition to the IDLE/INACTIVE mode, etc.). The RA-RNTI is calculated based on the PRACH (physical RACH) occasion at which the random access message is to be sent to the network.

The gNB, upon receiving Msg1, may respond with Msg2 that comprises a Random Access Response (RAR). The network also sends a DCI (Downlink Control Indicator or information) in the PDCCH that is scrambled with the RA-RNTI, which is used by the WTRU to determine on which resources (e.g., time and frequency resource) the RAR (and other related info) is provided to the WTRU. The WTRU tries to detect this DCI within a period of time after sending the preamble (known as the RAR-window). If such DCI is not received, the WTRU may retransmit the preamble. If the DCI is received, the WTRU will get the RAR at the provided time and frequency resources, in the PDSCH. In the RAR and associated information, the WTRU will be provided with a timing advance (TA) to apply for sending UL data, the TC-RNTI (Temporary Cell RNTI), and the UL resources to send the setup/resume request message.

Two types of random access are supported in NR: 4-step RA (RACH), and 2-step RA (RACH). The 2-step RACH procedure is useful in scenarios where latency is important, since the signaling exchange necessary to complete the random access procedure is reduced.

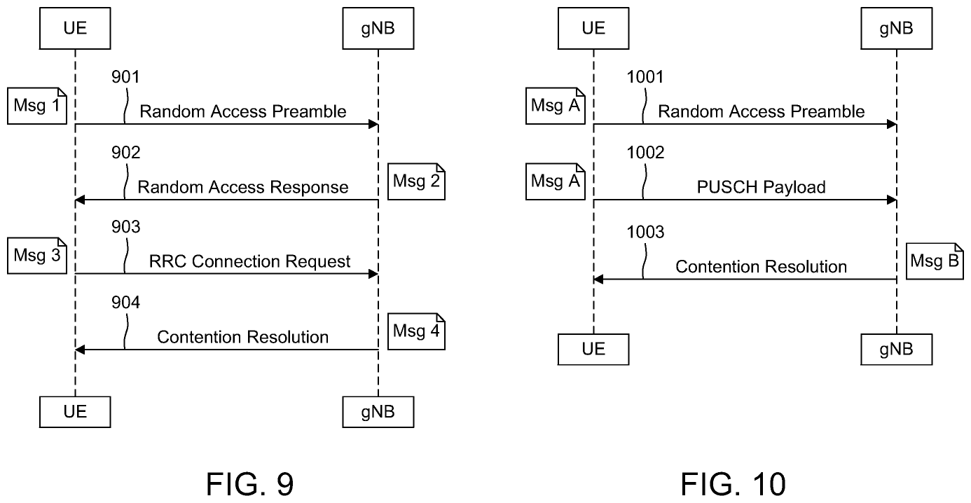

A 4-step random access procedure is illustrated in FIG. 9. The procedure is as follows: (1) 4-step random access begins with the WTRU transmitting Msg1 901, which comprises a preamble on a PRACH. Upon Msg1 901 transmission, the WTRU monitors for a random access response (e.g., RAR/Msg2) 902 from the network within a configured window. (2) Upon reception of the RAR 902, which comprises an UL grant and a timing advance command, the WTRU applies the timing advance command and sends a Msg3 903 using the UL grant provided in the RAR. (3) Upon Msg3 903 transmission, the WTRU again monitors for a network response (e.g., Msg4) 904 comprising contention resolution information. (4) If contention resolution is successful, random access is complete and the WTRU begins the connection. If contention resolution fails, the WTRU restarts random access via transmission of Msg1 901 again.

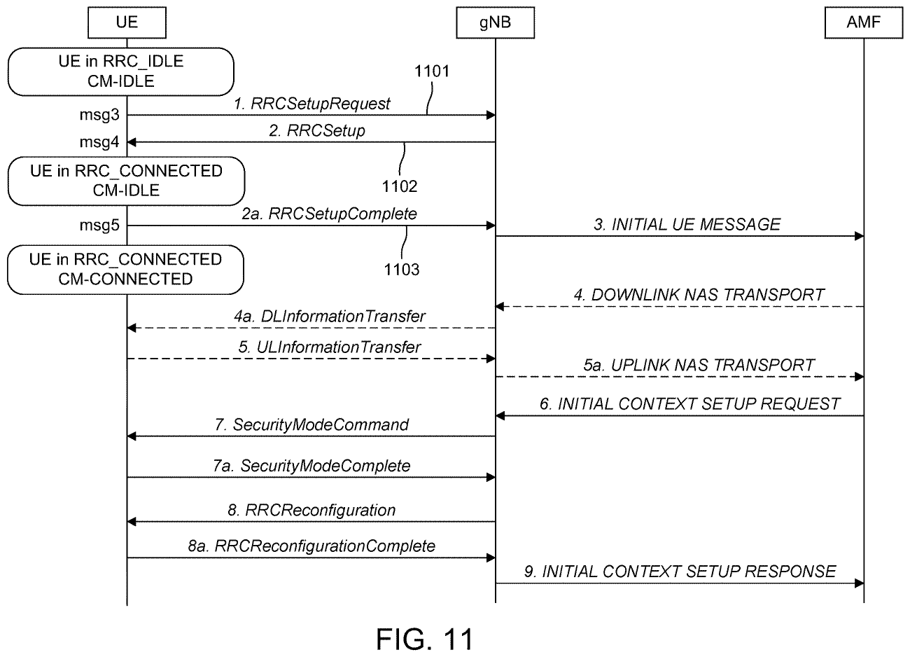

A 2-step random access procedure is shown in FIG. 10. The procedure is as follows: (1) 2-step random access begins with transmission of MsgA, which comprises a preamble on a PRACH 1001 and a payload on a PUSCH 1002. After MsgA transmission 1001, 1002, the WTRU monitors for a response (e.g., MsgB) 1003 from the network within a configured window comprising information regarding contention resolution. (2) If contention resolution is successful, the WTRU terminates the random access procedure. If contention resolution fails and a fallback indication is provided in MsgB 1003, the WTRU performs a Msg3 transmission using an UL grant contained within the MsgB fallback indication, and begins to monitor for contention resolution (step omitted in the figure). If contention resolution again fails after Msg3 transmission, the WTRU reverts back to MsgA transmission (step omitted in the figure). If the MsgA transmission fails a configured number of times, the WTRU may revert back to a 4-step random access procedure (step omitted in the figure)

The type of random access procedure to be used (e.g., 4-step or 2-step) is selected upon initiation of the random access procedure and it is based on a network configuration. When contention free random access resources are configured, the WTRU performs 4-step or 2-step random access depending, on whether the random access resources correspond to 2-step or 4-step. If contention free random access resources are not provided, the WTRU selects between 4-step and 2-step random access based on an RSRP threshold.

During RRC connection setup or resume, the WTRU first performs the Random Access Channel (RACH) procedure described as described above. RACH procedure is executed before the WTRU sends an RRCSetupRequest or an RRCResumeRequest message. The RACH procedure serves two main purposes: to get UL synchronization between the WTRU and the network (e.g., gNB) and to obtain the resources that are to be used for the sending of the request message. The WTRU may get the detailed information/configuration regarding the usage of the random access channel, such as RACH occasion, random access response window, etc., via a dedicated configuration while in a CONNECTED mode, upon transitioning during an IDLE/INACTIVE mode, or from System Information Broadcast (SIB).

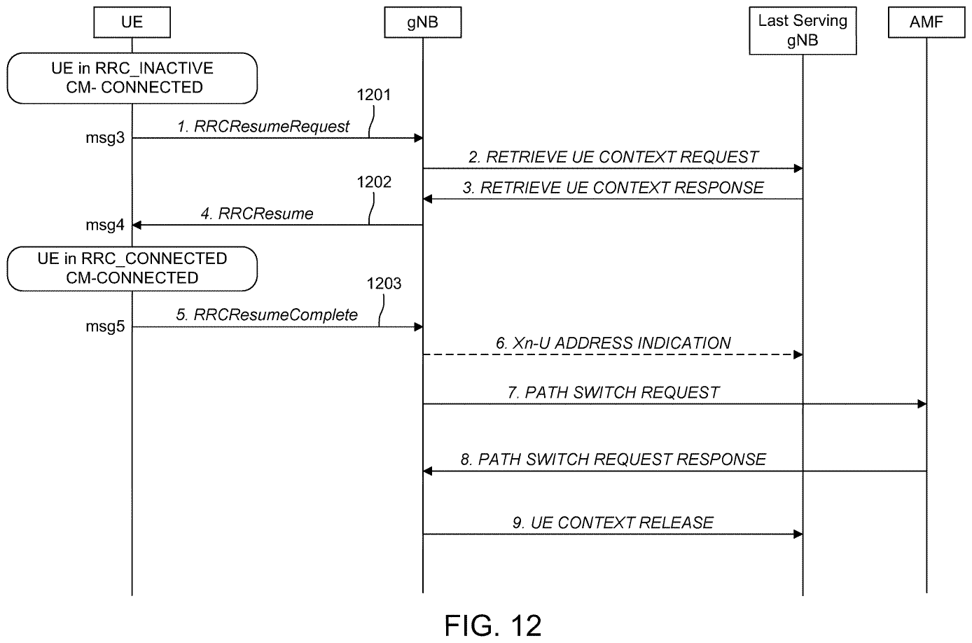

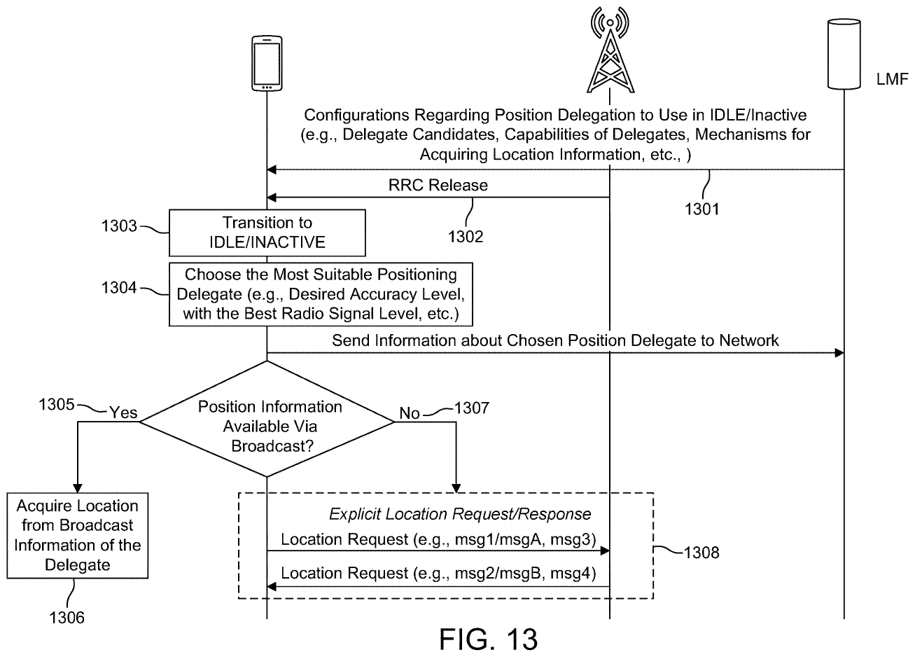

FIG. 11 shows an RRC connection establishment/setup procedure. FIG. 12 shows an RRC connection resume procedure. The RA procedure is omitted in FIG. 11 and FIG. 12.

The term Msg3 is used to refer to RRCSetupRequest 1101 or RRCResumeRequest 1201. The term Msg4 is used to refer to RRCSetup 1102 or RRCResume 1202. The term Msg5 is used to refer to RRCSetupComplete 1103 or RRCResumeComplete 1103.

As can be seen in FIG. 11, the RRC connection setup procedure is a lengthy procedure that requires several round trip times to complete and it must involve the CN. This is because when the WTRU goes to IDLE mode, the WTRU's RRC context is released, and as such the WTRU is not known at the RAN level, and the RAN has to get the WTRU context from the CN. Also, security has to be re-established after that and the WTRU reconfigured with the DRBs and SRBs, before UL/DL data transmission/reception may occur.

Such a lengthy setup procedure is not compatible with low latency services and thus NR has introduced an intermediate mode between the CONNECTED and IDLE mode, known as the INACTIVE mode. This mode has most of the power saving advantages of the IDLE mode (e.g., WTRU does not need to continuously monitor the PDCCH, which is one of the most power consuming procedures in the CONNECTED mode), but at the same time, the RAN still keeps the WTRU's RRC/Security context. When there is a need to transition the WTRU to CONNECTED mode (e.g., due to the arrival of UL data or the reception of a paging indicating the arrival of DL data), the connection may be resumed very quickly, without involving the CN, re-establishing the WTRU's security context, and reconfiguring the bearers.

When the WTRU performs the connection setup/establishment or resume procedure, it includes, in the RRCSetupRequest or RRCResumeRequest, the establishment or resume cause.

Currently, the establishment cause is defined as:

| | |
|---|---|
| EstablishmentCause ::= | ENUMERATED { |
| | emergency, highPriorityAccess, mt-Access, mo-P |
| | mo-Data, mo-VoiceCall, mo-VideoCall, mo-SMS, |
| | mps-PriorityAccess, mcs-PriorityAccess, spare6, |
| spare5, | spare4, spare3, spare2, spare1} |

Currently, the resume cause is defined as:

| | |
|---|---|
| ResumeCause ::= | ENUMERATED { emergency, highPriorityAccess, mt-Access, mo- |

Signalling,

| | |
|---|---|
| | mo-Data, mo-VoiceCall, mo-VideoCall, mo-SMS, rna- |
| Update, | mps-PriorityAccess,mcs-PriorityAccess, |
| | spare1, spare2, spare3, |

spare4, spare5 }

For example, if the connection is being setup/resumed due to a voice call or video call originating from the WTRU, the WTRU may set the establishment/resume cause to mo-VoiceCall (mobile originated voice call) or mo-VideoCall (mobile originated video call). In another example, if the connection is being setup/resumed due to a downlink paging indicating DL data, the WTRU may set the establishment/resume cause to one of mt-Access (mobile terminated access), highPriorityAccess, mps-PriorityAccess, or mos-PriorityAccess (depending on the access category of the WTRU).

When the WTRU is sent to an INACTIVE mode, the network includes in the RRCRelease message a SuspendConfig message. The SuspendConfig message may comprise the resumeldentity to be used by the WTRU (a short identity, shortl-RNTI, and a long identity, fulll-RNTI). The WTRU may determine which identity to use based on the system information broadcast in the target cell (e.g., if useFullResumeID is indicated in the SIB, use the long identity, otherwise, use the short identity). The SuspendConfig message may comprise the RAN paging area (e.g., list of cells), which is the RAN area where the WTRU may be paged at RAN level. If the WTRU performs cell re-selection to a cell outside the RAN area, the WTRU may perform a RAN area update procedure. The SuspendConfig message may comprise a nextHopChaining count, which is used for deriving the security context (e.g., encryption/integrity protection keys) upon resuming the connection.

The procedure used for a RAN area update is sometimes referred to as a “2 step resume” procedure, because the WTRU sends a ResumeRequest indicating a cell re-selection outside the RAN area, and the network responds with a Release message (e.g., including a new RAN area configuration). That is, the WTRU will remain in an INACTIVE mode, and the network now has information in which RAN area the WTRU may be accessible, if there is a need to page the WTRU (e.g., arrival of DL data at the RAN that is intended for the WTRU).

A small data transmission (SDT) procedure allows data and/or signaling transmission while remaining in an RRC_INACTIVE mode. SDT is enabled on a per radio bearer basis and applies if the following conditions are satisfied: (1) the amount of data across all radio bearers configured for small data transmission is less than a configured threshold; (2) the DL RSRP is above a configured threshold; and (3) a valid ST resource is available.

The SDT procedure is initiated with either a transmission over a RACH (which is configured via system information) or over Type 1 Configured Grant (CG) resources (configured via dedicated signaling in the RRCRelease message). CG resources are only valid within the cell which provided the RRCRelease message, and both 2-step and 4-step RACH may be used for small data transmission, based on NW configuration. The WTRU may only transmit small data over CG resources with a valid UL timing alignment, which is maintained by the WTRU based on an SDT-specific timing alignment timer configured by the network via dedicated signaling.

When using CG resources, the network may schedule subsequent UL transmissions via dynamic grants or on subsequent CG resource occasions. The WTRU may initiate subsequent UL transmissions only after reception of a confirmation (dynamic UL grant or DL assignment) for the initial PUSCH transmission from the network. When using RACH resources, the network may schedule subsequent UL and DL transmissions using dynamic grants and DL assignments respectively after completion of the random access procedure.

Once initiated, the SDT procedure is either successfully completed (e.g., after the WTRU is directed to RRC_IDLE or RRC_CONNECTED), or unsuccessfully competed (e.g., upon cell re-selection, expiration of an SDT failure detection timer, reaching maximum configured PRACH preamble transmission, or expiration of an SDT-specific time alignment timer).

It may be desirable to have some aspects of positioning measurements/signaling/calculation functioning even when the WTRU is in an IDLE/INACTIVE mode. For example, the WTRU may want to monitor its location and apply some behavior depending on that (e.g., depending on the needs of higher layer applications, etc.). For example, in mobile originated location request (MO-LR) scenarios, the WTRU may be expected to report positioning information to application/higher layers in the WTRU on a periodic or event-triggered basis.

However, performing positioning related measurements/signaling/calculations is not compatible with the WTRU power saving goals of an IDLE/INACTIVE mode. Also, UL based positioning (e.g., using SRS for positioning) may not be feasible in some scenarios while the WTRU is in an IDLE/INACTIVE, without transitioning the WTRU back to a CONNECTED mode. Thus, using a positioning delegation concept for IDLE/INACTIVE WTRUs is an attractive solution that can be employed while still keeping the WTRU power saving goals of the WTRUs in those modes. However, currently there are no procedures to support position delegation while the WTRU is in an IDLE/INACTIVE mode.

The (mobile) IAB scenarios discussed herein are illustrative example scenarios and the solutions proposed herein may be applicable to any scenario where there are a group of WTRUs that are in close vicinity with each other that are being served by the same or a neighboring node(s). For the sake of brevity, most of the solutions discussed herein consider GNSS to be the alternative to cellular network based positioning available to the WTRU. However, as described above, a multitude of positioning methods that are not based on mobile networks are available and tare also applicable. The terms position delegate, positioning delegate or position delegate are used to refer to an entity (e.g., IAB node, a gNB with a small coverage area, another WTRU, etc.) that is performing positioning related operations on behalf of a WTRU (e.g., measurements/calculations/reporting, etc.). An LMF is a non-limiting example of a node or entity (e.g., network node or entity) that may be used for positioning or to support positioning. Any other node or entity may be substituted for LMF and may still be consistent with this disclosure. In the descriptions herein, the terms “activity level”, “mode”, and “state” may be used interchangeably (e.g., IDLE activity level, IDLE mode, and IDLE state). In the descriptions herein, the terms “camping cell” and “serving cell” may be used interchangeably. In the descriptions herein, when describing some messages, a shorter version is used (e.g., Release message instead of RRCRelease, etc.).

The WTRU may be provided configuration information needed to support the positioning delegation functionality.

In one embodiment, a WTRU may receive information related to one or more position delegates. In one example, the information may be received while the WTRU is in a second activity level. In another example, the information may be received during a transition from the second activity level to the first activity level. In an example, the information may be received while in the first activity level. In one embodiment, the first activity level may be an Radio Resource Control (RRC) IDLE or an RRC INACTIVE connection mode and the second activity level may be an RRC CONNECTED mode. In an example, the information may be used while in a first activity level. The WTRU may receive information about the positioning capabilities of the position delegates and how to get location information from the position delegates (e.g., via explicit request, via broadcast information, etc.). The WTRU may transition from the second activity level to the first activity level, for example in response to a received message (e.g., RRC Release message). The WTRU may select a position delegate that is most suitable for the needs of the WTRU and WTRU conditions (e.g., that has the desired accuracy level, with the best signal level, higher layer applications, etc.). The WTRU may acquire or receive the location information (e.g., absolute or relative) from the position delegate while in the first activity level (e.g., periodically, over a configured periodicity, or intermittently depending on the need of the WTRU and/or applications such as a need of a higher layer application) by doing one or more of the following: reading system information of the position delegate; sending a request in a Msg1 during a 4-step random access (RA) procedure (RACH) receiving the location either implicitly or explicitly in a Msg2; sending a request in a MsgA during a 2-step RA procedure and receiving the location either implicitly or explicitly in a MsgB; or sending a request in a Msg3 (e.g., RRC Resume Request) and receiving the location either implicitly or explicitly in a Msg4 (e.g., RRC Release). The location request and reception of the location information from the chosen position delegate may be performed using small data transmission (SDT) procedures and resources.

A WTRU may be provided the position delegate information from the Base Station (eNB, gNB), or the LMF (or equivalent location management server), or IAB-node, or another network node such as AMF, or a combination thereof. The WTRU may be provided the configuration information in RRC IDLE, INACTIVE or CONNECTED, or a combination thereof.

A WTRU may be provided with a position delegate information while in a CONNECTED mode (e.g., RRC reconfiguration message). A WTRU may be provided with a position delegate information during a transition to IDLE/INACTIVE mode (e.g., RRC Release message). A WTRU may be provided with information regarding the position delegation capability of a cell that it is camping on while in an IDLE/INACTIVE mode (e.g., broadcast information in the camping). A WTRU may be provided with information regarding the position delegation capability of a neighbor cell while camping on another cell in an IDLE/INACTIVE mode (e.g., via broadcast information of the serving cell or via broadcast information of the neighbor cell). The position delegation information may include a simple information (e.g., one bit information) whether positioning delegation is supported.

In one embodiment, the position delegation information may include one or more of the following information: the positioning method employed by the delegate (e.g., WTRU-assisted, WTRU-based, DL-based, UL-based, GNSS, etc.); the accuracy level/estimate (e.g., confidence interval in % or absolute values, confidence/accuracy level/percentage, etc.); how the position information is provided by the delegate is provided, which may be one or more of: push procedures such as broadcast (including information about location broadcast periodicity); pull procedures such as by WTRU request; or a combination where the WTRU may request/subscribe for a position delegation and the position delegate may provide the location to the WTRU on an agreed upon periodicity (in that case, what periodicities are supported); and whether absolute locations may be provided via broadcast or only relative locations (e.g., WTRU may have to get absolute locations via dedicated signaling or procedures and then get relative position changes via broadcast signaling or procedures). In one embodiment, the WTRU may receive a relative location information from the network (e.g., delta location from a previously provided location).

In one embodiment, the position delegation information may comprise information for more than one position delegate (e.g., list of position delegate identifiers, such as cell ID of a mobile cell or WTRU ID of a position delegate WTRU, and corresponding positioning delegation information).

In one embodiment, the WTRU may be configured with information about one or more position delegates at an application layer, manually, or another means outside the RAN.

The indication of positioning delegation may be an implicit indication. For example: the concerned cell (e.g., camping cell, neighbor cell) is broadcasting location information, the concerned cell is a mobile IAB cell, the WTRU may receive broadcasting of location information from the concerned cell that has an associated LPP session ID which may also be associated with the unique ID for the WTRU (e.g., RTNI, resume identity, etc.) or a group of WTRUs, indicating the concerned node/cell has already established an LPP session with the LMF on behalf of the WTRU.

A WTRU may be configured with different periodicities for acquiring location information that may be dependent on a time of the day (e.g., different periodicities for different time intervals).

A WTRU may be configured with different periodicities for acquiring location information that may be dependent on a current location of the WTRU (e.g., different periodicities for different range of location coordinates).

A WTRU may be configured with different periodicities for acquiring location information that may be dependent on a current mobility state of the WTRU (e.g., different periodicities for different range of WTRU speed, for example, no mobility, low mobility, medium mobility, high mobility, etc.).

A WTRU may be configured with different periodicities for acquiring location information that may be dependent on a signal level with the current camping cell (e.g., different periodicities for different range of camping cell's RSRP, different periodicities depending on how fast/slow the RSRP is changing, etc.).

A WTRU may be configured with different periodicities for acquiring location information that may be dependent on a change (e.g., rate of change) of the location as indicated from previous acquisitions (e.g., less frequent acquisitions if a certain number of consecutives acquired locations are not that different from each other, more frequent acquisitions if there is a considerable difference in consecutive acquired locations, etc.).

Based on above information, the WTRU may decide whether or not to use a position delegate. In one embodiment, the WTRU selects a delegate and temporarily or sporadically determines its own position (e.g., measuring positioning signals and estimating its own position) and compares it with the location provided by the delegate. The WTRU may continue to use the location information provided by the delegate if there is a consistent difference or if the difference is small compared to the required accuracy.

A WTRU may be configured for using a position delegate while in an IDLE/INACTIVE mode and read system information (e.g., a particular SIB for getting location information) of the camping cell to get the location information.

A WTRU may be configured for using a position delegate while in an IDLE/INACTIVE mode and receive location information by sending a request to the network, without transitioning to a CONNECTED mode.

A WTRU may be configured to receive the location information from the delegate at a certain periodicity (e.g., read the concerned SIB or do the request for location information every x msec, etc.). The WTRU may receive absolute location information from the network.

A WTRU that is configured to use a position delegation in an IDLE/INACTIVE mode, upon determining that the new camping cell does not support position delegation, may send an indication to the network regarding this, without transitioning to a CONNECTED mode.

A WTRU that is configured to use a position delegation in an IDLE/INACTIVE mode, upon determining that the new camping cell does not support position delegation, may trigger a connection resume or connection establishment (e.g., including a new establishment or resume cause value indicating that).

A WTRU that is configured to use a position delegation in an IDLE/INACTIVE mode, upon determining that the new camping cell does support position delegation (while the previous camping cell did not), may send an indication to the network regarding this, without transitioning to a CONNECTED mode.

A WTRU that is configured to use a position delegation in an IDLE/INACTIVE mode may prioritize camping on a cell that provides a position delegation, even though that cell may not be the best cell according to legacy cell re-selection principles. For example, the WTRU may be configured to apply a positive offset on top of the measurements of cells (e.g., current serving cell, neighbor cell, etc.) that may provide a position delegation. In an alternative embodiment, the WTRU may be configured to apply a negative offset on top of the measurements of cells (e.g., current serving cell, neighbor cell, etc.) the does not provide a position delegation.

A WTRU may be configured with different offset values/ranges, depending on the position capabilities of the delegate (e.g., different values or range of values for different accuracy levels or/and positioning methodology or/and periodicity of location update, etc.).

A WTRU may be configured to apply the offsets, or apply different offsets, depending on the current WTRU conditions. For example, the WTRU may be configured to start applying the offsets or start using higher offsets for position delegate cells if its battery level is below a certain level or/and if it determines that its own positioning determination is not accurate enough anymore (e.g., when indoor, etc.).

A WTRU may be configured to camp on the best cell according to legacy principle (e.g., best cell, from signal level perspective, on the prioritized frequency/RAT), but when it is time to get the location information, it will get the position from a neighbor cell that provides a position delegation (e.g., reading the SIB of that neighbor cell, sending a request to that neighbor cell, etc.).

A WTRU may be configured with timing information (e.g., a specified time duration) and/or location margin information (e.g., absolute or relative offset) that may be related to performing positioning measurements while camping on a node/cell that is a position delegate. For example, the WTRU may be configured to keep performing the positioning measurements for a specified duration after camping on a cell that is a position delegate and compare the location information that it has determined with the location information provided by the delegate. If during this time, the location that is determined is the same with the location provided by the delegate, or within a specified absolute or relative location margin, the WTRU may consider the location determination being done by the delegate to be accurate enough and stop performing its own location determination (e.g., performing the GNSS or PRS measurements). The WTRU may send an indication to the network (e.g., LMF) about this (e.g., that it has checked the location accuracy provided by the delegate and stopped performing the measurements itself). This may be done without the WTRU transitioning to a CONNECTED mode.

A WTRU may determine its own location and keep comparing the location disparity between the one it has determined and the one provided by the position delegate. This comparison process may happen for a certain specified duration or for a number of occasions. If there is a considerable difference between the two (e.g., above a certain margin) but the difference is consistent (e.g., within another specified margin), the WTRU may consider the location information provided to by the delegate to be accurate enough and stop the location determination by itself (e.g., performing the GNSS or PRS measurements). The WTRU may consider that difference when it receives the future location information from the delegate. The WTRU may send an indication to the network (e.g., LMF) about this (e.g., that it has checked the location accuracy provided by the delegate and it has detected a consistent difference of x meters between the two and has stopped performing the measurements). The LMF may thus apply the difference on top of the location provided by the delegate to determine a more accurate location of the WTRU. This may be done without the WTRU transitioning to a CONNECTED mode.

A WTRU may be configured to sporadically or periodically start the location measurements and or determination while in an IDLE/INACTIVE mode to check if the location provided by the delegate is still accurate or the difference is consistent. For example, the WTRU may be configured to perform the location determination/comparison every x minutes. The WTRU may send an indication to the network if the location information is still accurate or consistent. This may be done without the WTRU transitioning to a CONNECTED mode.

A WTRU may be configured to send an indication to the network when the position delegation is not used/needed anymore (e.g., position delegation accuracy is not good enough, as determined during the initial camping on a cell or during the sporadic/periodic checking while camping in the cell, etc.). The WTRU may be configured to trigger a connection establishment/resume, and add a cause value indicating that the position delegation is not used/needed anymore. The WTRU may send the information to the network without transitioning to a CONNECTED mode.

As it was described above, enabling the WTRU to send a position request to the network, or receive location information from the network, or send additional information regarding usage of the position delegation, while remaining in an INACTIVE/IDLE mode, is beneficial, for example, in terms of reducing power consumption and signaling overhead. The repurposing of existing messages to support the positioning delegation functionality may also contribute positively to the reduction of power consumption and the reduction of signaling overhead. The procedures that are part of the behavior of a WTRU today may be enhanced to support the location process.

A WTRU may request a location update from the delegate by performing a 2-step resume like approach. For example, the WTRU may send a resume/setup request message using a specific cause value (e.g., position_update_request). The WTRU may further indicate additional information in the resume/setup request message (e.g., if the requested location information is absolute or relative, etc.). The network may send the location information in a release message. In an embodiment, the network may send the location information in a resume message.

In order to enable the communication to the network about the starting or stopping of the usage of position delegation, or to perform cell reselection from a cell that supports delegation to the one that does not (or vice versa), the WTRU may perform a 2-step resume like approach. For example, the WTRU may send a resume/setup request message using a specific cause value (e.g., position_delegation_started, position_delegation_stopped, cell_reselection_to_a_position_delegate, cell_reselection_away_from_a_delegate, etc.) and the gNB may inform the LMF about that. The resume request may include information about the difference/deviation between the location provided by the delegate and the location initially measured/determined by the WTRU. The network may respond to the WTRU with a release message. The release message may include information about other alternative positioning delegates or may be used to configure the WTRU to perform positioning measurements while in an IDLE/INACTIVE mode). Alternatively, the network may decide to resume or establish the connection of the WTRU (e.g., if the WTRU has indicated the stoppage of using delegation) as the network may want the WTRU to move to CONNECTED mode in order to start performing UL based positioning, for example, via SRS.

The information to support the positioning delegation functionality may indicate a specific method to request a location update. For example, the WTRU may be provided with one or more of a set of preambles; a set or RACH occasions; or a dedicated RNTI. The information to support the positioning delegation functionality may be provided to the WTRU via one or more of the following methods: within system information; via a dedicated RRC message (e.g., in an RRC Release and/or RRC Release with Suspend message); or via a random access message (e.g., Msg2, Msg4, and/or MsgB), or a combination thereof.

A WTRU may assume that the information to support the positioning delegation functionality provided (e.g., RACH preamble, RACH occasions, etc.) may be valid in one or more of the following: indefinitely (e.g. for any serving cell, or regardless of RRC mode, until it is told otherwise); for all serving cells within a tracking area (TA) or RAN area; for all cells served by the same CU; for all cells served by the same DU; for an indicated set of cell IDs (e.g., PCls, PCI ranges, etc.); within the same serving cell that broadcast the configuration/indication; while the WTRU remains in an RRC_INACTIVE mode (e.g., upon transition to RRC IDLE, a WTRU may no longer assume that the configured preambles and/or RACH occasions may be valid for a location update request); for a specific signaling method e.g., a WTRU may only assume that preambles and/or RACH occasions are valid for one or more of: 4-step random access; 2-step random access, SDT via RACH, or SDT via configured grant); and for the case where RSRP is above a threshold (e.g., if the measured SSB is above a pre-configured threshold).

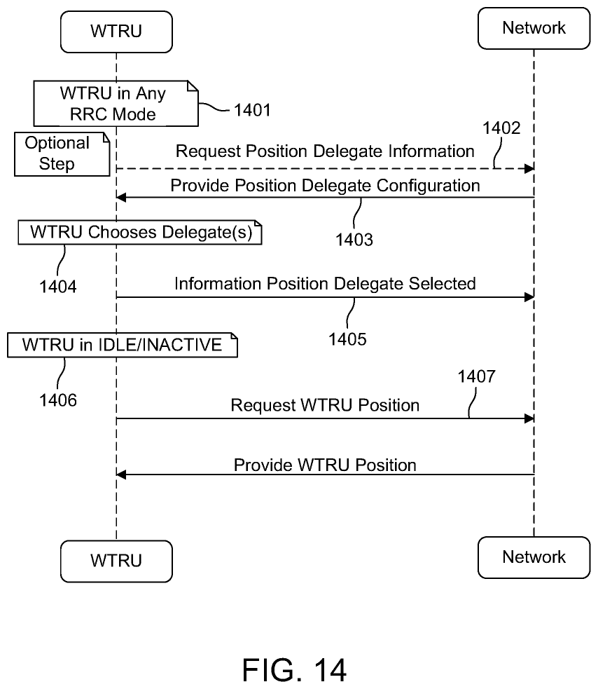

FIG. 13 shows an example where the location information may be sent in the broadcast channel or via a dedicated request/response process while the WTRU is in IDLE/CONNECTED mode. The WTRU may receive the configuration in RRC CONNECTED mode 1301. The configuration information may include one or more of the following information: the one or more candidate delegates with their associated identifiers; the candidate delegate capabilities (e.g., positioning method used, accuracy level, offsets based on capabilities, QoS support); the method for obtaining location information from network (e.g., broadcast, request/response, reserved resources, LPP protocol, RRC protocol); whether location information can be provided periodically or intermittently or is event driven; absolute versus relative position provisioning; the positioning method employed by the delegate (e.g., WTRU-assisted, WTRU-based, DL-based, UL-based, GNSS, etc.); the accuracy level/estimate (e.g., confidence interval in % or absolute values, confidence/accuracy level/percentage, etc.); how position information is provided, which may be one or more of: push procedures such as broadcast (including information about location broadcast periodicity), pull procedures such as by WTRU request, a combination where the WTRU may request/subscribe for a position delegation and the position delegate may provide the location to the WTRU on an agreed upon periodicity (in that case, what periodicities are supported); whether absolute locations may be provided via broadcast or only relative locations are provided (e.g., WTRU may have to get absolute locations via dedicated signaling or procedures and then get relative position changes via broadcast signaling or procedures); and configuration of preambles and/or RACH occasions used for a location update, detailed information/configuration regarding the usage of the random access channel, such as RACH occasion and random access response window. The configuration may include configuration for Reference Signals (SRS, PRS) for the serving cell and, optionally, for neighbor cells; measurement configuration; and any location influencing factors (e.g., mobility, location, time of day).

A WTRU may be provided the position delegate information from the Base Station (eNB, gNB), or the LMF (or equivalent location management server), or IAB-node, or another network node such as AMF, or a relay WTRU, or another WTRU, or a combination thereof.

The network may release the RRC connection 1302 sending the WTRU to RRC IDLE or RRC INACTIVE mode 1303. The WTRU may select the delegate 1304 based on one or more of the radio signal level, the desired accuracy level, and the configuration information to support the positioning delegation functionality, among other factors. The information regarding which delegate was selected may be sent to the LMF and/or gNB. When the location is determined by the delegate, the delegate may send the location information in the broadcast channel 1305, the WTRU may read the broadcast channel to acquire its location information 1306. If the delegate does not send location information in the broadcast channel 1307, an explicit request/response for location update 1308 may be needed. The explicit request/response procedure for location update may occur in RRC IDLE or INACTIVE. The explicit request/response procedure may be done by repurposing existing messages.

The WTRU may indicate the starting/stopping of using the position delegation, or a cell re-selection towards a position delegate, or a cell-reselection away from a position delegate, by using specific preambles configured for that purpose in Msg1. The WTRU may request a location update from the delegate by using specific preambles configured for that purpose in Msg1. The WTRU may request a location update from the delegate by using specific RACH occasions configured for that purpose. The WTRU may request a location update from the delegate by using a specific RNTI configured for that purpose. The WTRU may request a location update from the delegate by using a combination of specific preambles and/or RACH occasions and/or RNTIs configured for that purpose in Msg1.

The WTRU may receive a location update from the delegate in a Msg 2. For example, if the WTRU initiates random access via one or more of the above methods (e.g., via dedicated preambles and/or RACH occasions and/or RNTIs), and the resources remained valid (e.g., Msg1 transmission occurred on a valid cell), the WTRU may assume that the Msg2 contains a location update. The location update may be included in Msg2 by repurposing one or more of Msg2 fields, for example the TAC (Timing Advance Command) field and/or the UL grant field(s) for Msg3 transmission. The WTRU may receive an indication regarding which field(s) are repurposed, for example be indicated by: explicitly indicated within Msg2 (e.g., via Msg2 header and/or flag); indicated via system information; pre-configured via RRC (e.g., indicated within a RRCRelease or RRCRelease with suspend indication); or provided within a CG (Configured Grant) configuration.

A WTRU may alternately determine whether a field may be repurposed, for example, based on one or more of the following conditions: if the RSRP is above a configured threshold, the TAC field may be repurposed; or if the WTRU does not require to transition to connected or requires any further information, the Msg3 UL grant field may be repurposed.

Upon successful acquisition of location information in Msg2, the WTRU may, for example, perform one or more of the following actions: stop a random access procedure; continue a random access procedure; restart a random access procedure; remain in RRC_INACTIVE; and remain and/or transition to RRC_IDLE.

A WTRU may request a location update during Msg3 transmission. For example, the WTRU may include an explicit request in a Msg3 PUSCH resource. Whether the WTRU may request a location update in Msg3 may also be based on whether the WTRU has previously requested location information during a Msg1 transmission and/or Msg3 transmission.

The WTRU may request a location update from the delegate by using specific preambles and/or RACH occasions and/or RNTIs configured for that purpose in a MsgA during 2-step RACH. The WTRU may include a request for location information within a MsgA PUSCH resource. Whether the WTRU may include a request for location information in the PUSCH resource may depend on whether the MsgA preamble was used for a location request. For example, the network may interpret one or more fields of the MsgA PUSCH resource differently (e.g., for the purposes of location request) based on the contents or the MsgA preamble.

The WTRU may indicate the starting/stopping of using the position delegation, or a cell re-selection towards a position delegate, or a cell-reselection away from a position delegate, by using specific preambles configured for that purpose in a MsgA during 2-step RACH.

The WTRU may receive a location update from the delegate in a MsgB during 2-step RACH. For example, the contents of MsgB may be modified similar to Msg2. In another example, the location information may be provided in a MsgB PDSCH resource.

A WTRU may be configured to transmit a location request and/or receive a location update using a Small Data Transmission (SDT) procedure. Whether a WTRU may use an SDT procedure for a location request may be subject to a configuration (e.g., based on one or more of an enable/disable indication, based on a configuration per radio bearer, based on RSRP threshold, or based on SDT type such as RACH based SDT or CG-based SDT).

In one embodiment, a WTRU may only request a location update in an initial SDT. In another example, a WTRU may only request location information within a dynamic grant received in response to an initial SDT.

In one example, upon successful acquisition of location information during an SDT procedure, the WTRU may stop a random access procedure and/or the SDT on procedure. In another example, the WTRU may continue the SDT procedure.

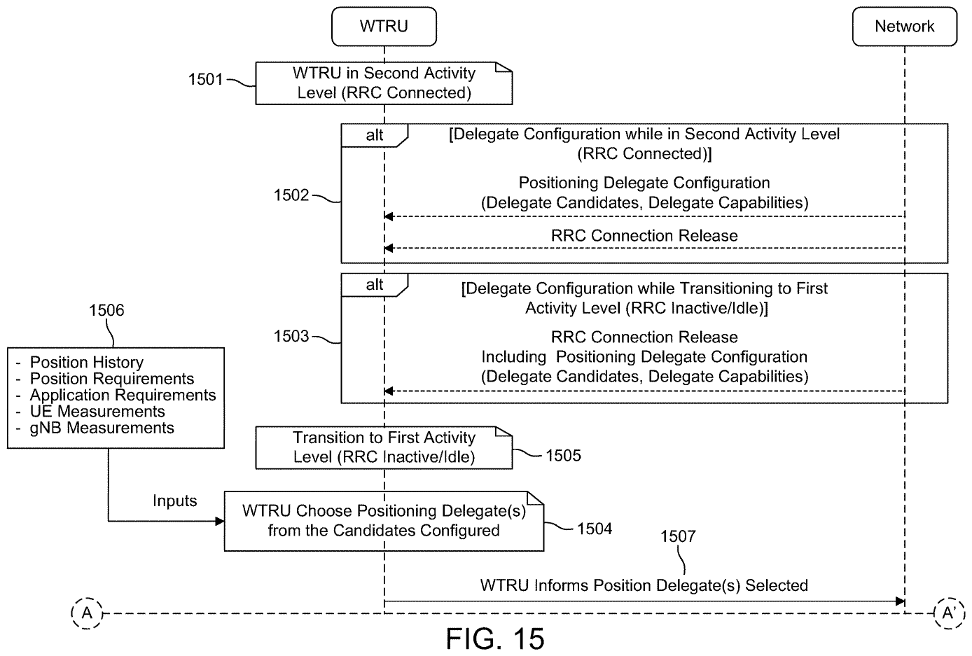

FIG. 14 depicts a high-level view of an example of the position delegation procedure. In one example, a WTRU may be in any mode, RRC IDLE, INACTIVE, or CONNECTED) 1401. In one example, a WTRU may request the configuration information to support the positioning delegation functionality from the network 102. Optionally, the network may autonomously configure a WTRU 1403. The configuration information provided is to be used in RRC IDLE mode. A WTRU may select the most suitable positioning delegate 1404 based on several factors, e.g., desired accuracy, desired method to determine position, location history, WTRU location, WTRU speed, etc. A WTRU may inform the network (e.g., gNB, LMF) about the selected delegate 1405. When a WTRU is in RRC IDLE or RRC INACTIVE 1406, it may obtain its location information from the selected delegate 1407 without transitioning to RRC CONNECTED mode. The position delegate may be a gNB, an IAB node or a WTRU. The position delegate may determine the location of a specific WTRU on behalf of the WTRU, allowing the WTRU to stay in INACTIVE or IDLE mode.

In one embodiment, the WTRU may receive configuration information to support the positioning delegation functionality including the candidates for position delegate from the network. This information may include a list of position delegate candidate identifiers; for each candidate delegate: the delegate capabilities such as positioning method used, accuracy level; the method used by the delegate to determine the position; information on the Reference Signal(s) (RS) such as PRS, SRS, etc.; measurement configuration; the support of periodic and/or event based position determination; and absolute versus relative position provisioning.

While a WTRU is in RRC IDLE/INACTIVE it may receive location information from the delegate. The WTRU may use that information and maintain a history of location information, allowing to calculate statistics, compare consecutive positions, and use the historical data to refine its positioning requirements.

Depending on the accuracy desired, a WTRU may use the position of the delegate as its own position. In one example, a mobile IAB-node may in a train or bus and may determine its own position. A WTRU, also in the train or bus, may determine its own position once, and then calculate its distance from the mobile IAB node. From that point forward, if the mobile IAB broadcasts its own position, the WTRU may calculate its own position as well.

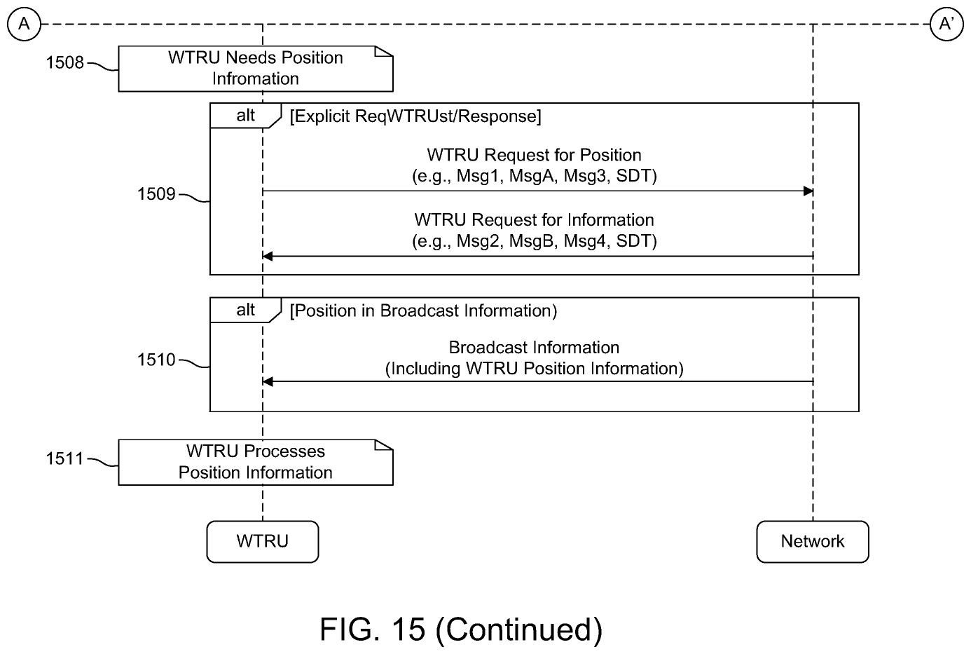

FIG. 15 shows one embodiment of the positioning delegation procedure where the WTRU may be in a first or a second activity level. It is noted that FIG. 15 is split in 2 figures, FIG. 15 and FIG. 15 (Continued) The first activity level in may correspond to RRC IDLE or RRC INACTIVE and the second activity level may correspond to RRC CONNECTED. A WTRU is in the second activity level 1501. The configuration information to support the positioning delegation functionality may be received by a WTRU while the WTRU is in the second activity level 1502 or during the transition between the second activity level to the first activity level 1503 (e.g., in the RRC Connection Release message). A WTRU may select the position delegate 1504 after transitioning to the first activity level as it is shown in 1505. Optionally, a WTRU may select the position delegate while the WTRU is in the second activity level or during the transition between the second activity level to the first activity level (option omitted from figure). In one example, the position delegates may be used while the WTRU is in the first activity level 1505. Optionally, the WTRU may use the position delegate in any activity level (option omitted from). A WTRU may use other information besides the candidate configuration when selecting a delegate, such as position history, position requirements, application requirements, WTRU measurements, gNB measurements, etc. 1506. The WTRU informs the network of the selected position delegate 1507.

Referring to FIG. 15 (Continued), when a WTRU needs location information 1508, it may use a request/response procedure over repurposed messages 1509 or receive it in the broadcast channel 1510. A WTRU may provide the location information to the LMF and/or to its applications and may also process and maintain statistics of the location information 1511, which may be used later by the WTRU e.g., as one of the inputs for the delegate selection process 1506.

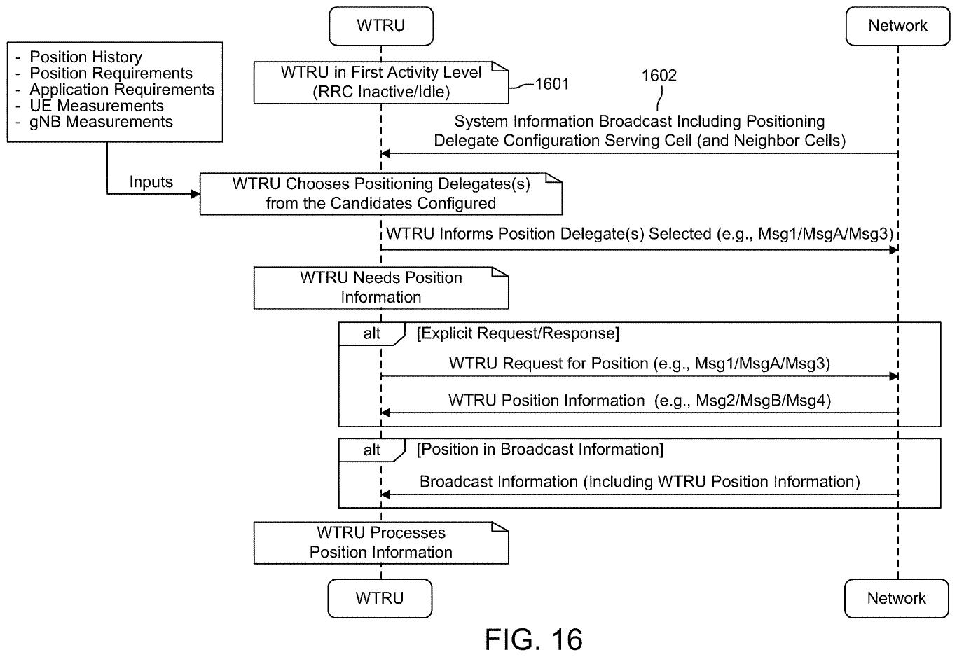

FIG. 16 shows another embodiment of the positioning delegation procedure. In this embodiment, the configuration may be sent to a WTRU when the WTRU is in a first activity level 1601. A WTRU may receive the configuration information via the broadcast channel 1602. The remainder of the procedure is equivalent to the one illustrated in the embodiment in FIG. 15.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

1.-22. (canceled)

23. A method for use in a Wireless Transmit/Receive Unit (WTRU), the method comprising:
receiving, from a network associated with the WTRU, configuration information comprising one or more identifiers, each of the one or more identifiers associated with one or more position delegate candidates to be used in a first activity level, wherein each position delegate candidate is a network node;
selecting a position delegate from the one or more position delegate candidates to be used in the first activity level;
transmitting, to the network, the one or more identifiers associated with the selected position delegate; and
receiving, from the selected position delegate, location information associated with the selected position delegate for use by the WTRU as a location of the WTRU.

24. The method of claim 23, wherein the first activity level is a Radio Resource Control (RRC) IDLE or an RRC INACTIVE mode.

25. The method of claim 23, wherein the receiving, from the network associated with the WTRU, configuration information comprising one or more identifiers, the transmitting, to the network, the one or more identifiers, and the receiving, from the selected position delegate, location information, are performed while the WTRU is in the first activity level.

26. The method of claim 23, further comprising:
transmitting, to the selected position delegate, a location request while in the first activity level.

27. The method of claim 26, wherein location request is included in a Msg1 or a Msg3 during a 4-step random access procedure.

28. The method of claim 26, wherein the location request is included in a MsgA of a 2-step random access procedure.

29. The method of claim 23, wherein the one or more identifiers are included in a Msg1 or in a Msg3 during a 4-step random access procedure.

30. The method of claim 23, wherein the one or more identifiers are included in a MsgA during a 2-step random access procedure.

31. The method of claim 23, wherein the location information is included in a Msg2 or in a Msg4 during a 4-step random access procedure.

32. The method of claim 23, wherein the location information is included in a MsgB during a 2-step random access procedure.

33. The method of claim 23, wherein the location information is received using a Small Data Transmission (SDT) procedure.

34. A Wireless Transmit/Receive Unit (WTRU), the WTRU comprising:
a processor;
a transceiver;
the processor and the transceiver configured to receive configuration information comprising one or more identifiers, each of the one or more identifiers associated with one or more position delegate candidates to be used in a first activity level, wherein each position delegate candidate is a network node;
the processor configured to select a position delegate from the one or more position delegate candidates to be used in the first activity level;
the processor and the transceiver configured to transmit to the network the one or more identifiers associated with the selected position delegate; and
the processor and the transceiver configured to receive, from the selected position delegate, location information associated with the selected position delegate for use by the WTRU as a location of the WTRU.

35. The WTRU of claim 34, wherein the first activity level is a Radio Resource Control (RRC) IDLE or an RRC INACTIVE mode.

36. The WTRU of claim 34, wherein the processor and the transceiver are further configured to transmit, to the selected position delegate, a location request while in the first activity level.

37. The WTRU of claim 36, wherein location request is included in a Msg1 or a Msg3 during a 4-step random access procedure.

38. The WTRU of claim 34, wherein the location request is included in a MsgA of a 2-step random access procedure.

39. The WTRU of claim 34, wherein the one or more identifiers are included in a Msg1 or in a Msg3 during a 4-step random access procedure.

40. The WTRU of claim 34, wherein the one or more identifiers are included in a MsgA during a 2-step random access procedure.

41. The WTRU of claim 34, wherein the location information is included in a Msg2 or in a Msg4 during a 4-step random access procedure.

42. The WTRU of claim 34, wherein the location information is included in a MsgB during a 2-step random access procedure.
